(19) United States
(12) Patent Application Publication
(10) Pub. No.: US 2015/0336125 A1
(43) Pub. Date: Nov. 26, 2015

(54) Rim Detailing Tool

(71) Applicant: Angel Luis Alvarez, Winter Garden, FL (US)

(72) Inventor: Angel Luis Alvarez, Winter Garden, FL (US)

(21) Appl. No.: 14/717,012

(22) Filed: May 20, 2015

Related U.S. Application Data
(60) Provisional application No. 62/000,954, filed on May 20, 2014.

(51) Int. Cl. B05B 15/04

(52) U.S. Cl. CPC B05B 15/0487

(57) ABSTRACT

The present invention provides a tire rim detailing tool configured to removably adhere to an inner edge of a wheel to enclose a tire rim. In this way, the tire rim is protected from any cleaning supplies that may damage the tire rim during car detailing. The tire rim detailing tool includes a body portion that is preferably circular and includes a front side and a rear side. The rear side includes an absorbent pad that extends along an outer edge of the body portion. The absorbent pad is removably attached to an inner edge of a wheel via an adhesive to prevent any cleaning supplies from damaging the tire rim. The front side includes a handle that extends along a diameter of the body portion. Furthermore, the body portion is foldable along the diameter and a pair of chords that are equally spaced from and parallel to the diameter.

### CROSS REFERENCE TO RELATED APPLICATION

This application claims the benefit of U.S. Provisional Application No. 62/000,954 filed on May 20, 2014. The above identified patent application is herein incorporated by reference in its entirety to provide continuity of disclosure.

### FIELD OF THE INVENTION

The present invention relates to vehicle accessories. More specifically, the present invention relates to tire rim detailing tools that protect the tire rim during car detailing.

### BACKGROUND OF THE INVENTION

Many people have an interest in vehicles and the customization of vehicles. One of the most popular ways to customize a vehicle is by installing a new set of tire rims. These tire rims are produced in a variety of styles, including mag wheels, modular wheels, alloy wheels, aluminum wheels, and many others. Generally to a car enthusiast, a new set of rims can vastly improve the appearance of any vehicle. However, properly caring for the new set of tire rims can be challenging.

Specifically, while detailing a car, many consumers use cleaning supplies, such as solvents and cleansers, that may leave undesirable and unattractive stains, markings or residue on the tire rims. These unattractive stains are often considered a time-consuming nuisance as additional work and extensive scrubbing is needed to remove these stains or streaks. Therefore, there exists a need for a device that provides a tire rim detailing tool that prevents any of these cleaning supplies from damaging the tire rim while car detailing.

Devices have been disclosed in the prior art that relate to wheel covers and tire rim covers. These include devices that have been patented and published in patent application publications. These include U.S. Pat. No. 6,860,568 to Nunes and U.S. Pat. No. 6,688,703 to Wang. The Nunes device comprises a wheel rim cover for a vehicle, which comprises a cover for fastening to a wheel rim. The rim cover, however, is bolted onto the rim of the wheel. The Wang device describes a wheel rim cover comprising a spring loaded fastening means which attaches to a wheel rim and creates an elevated effect for visual appearance. These devices, however, fail to describe the present invention including a rear side having an absorbent pad that extends along an outer edge of the circular body portion.

The present invention provides a tire rim detailing tool configured to removably adhere to an inner edge of a wheel to enclose a tire rim. In this way, the tire rim is protected from any cleaning supplies that may damage the tire rim during car detailing. The tire rim detailing tool includes a circular body portion having a front side and a rear side. The rear side includes an absorbent pad that extends along an outer edge of the circular body portion. The absorbent pad is placed in contact with an inner edge of a wheel and is removably adhered thereto via an adhesive. The absorbent pad is configured to prevent any cleaning supplies from coming into contact with the tire rim. The front side includes a handle that extends along a diameter of the circular body portion. Furthermore, the body portion is foldable along the diameter and a pair of chords that are equidistant from the diameter.

It is therefore submitted that the present invention is substantially divergent in design elements from the prior art, and consequently it is clear that there is a need in the art for an improvement to tire rim detailing tools. In this regard, the instant invention substantially fulfills these needs.

### SUMMARY OF THE INVENTION

In view of the foregoing disadvantages inherent in the known types of tire rim detailing tools now present in the prior art, the present invention provides a tire rim detailing tool wherein the same can be utilized for preventing damage to a tire rim by cleaning supplies used to enhance the appearance of tires and other areas of a car.

It is therefore an object of the invention to provide a new and improved tire rim detailing tool that has all of the advantages of the prior art and none of the disadvantages.

Another object of the present invention is to provide a new and improved tire rim detailing tool that includes a body portion that is preferably circular in shape and sized appropriately to enclose a variety of sizes of tire rims.

Yet another object of the present invention is to provide a new and improved tire rim detailing tool, wherein the tire rim detailing tool includes a front side and a rear side.

Still yet another object of the present invention is to provide a new and improved tire rim detailing tool, wherein the front side includes a handle portion along a diameter of the body portion.

A further object of the present invention is to provide a new and improved tire rim detailing tool, wherein the rear side includes an absorbent pad along an outer edge of the body portion that is removably attached to an inner edge of a tire via an adhesive.

Yet a further object of the present invention is to provide a new and improved tire rim detailing tool that is foldable along the diameter of the body portion to form a pair of halves, wherein each halve is foldable along a chord of the body portion to allow for easy transport and storage.

Still yet another object of the present invention is to provide a new and improved tire rim detailing tool wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective of the present invention.

FIG. 2 shows a rear perspective of the present invention.

FIG. 3 shows a side perspective of the present invention removably attached to a tire.

FIG. 4 shows an overhead perspective of the present invention folded along a diameter and a pair of chords for easy transport and storage.

### DETAILED DESCRIPTION OF THE INVENTION

Reference is made herein to the attached drawings. Like reference numerals are used throughout the drawings to depict like or similar elements of the tire rim detailing tool. For the purposes of presenting a brief and clear description of the present invention, the preferred embodiment will be discussed as used for enclosing a tire rim to protect the tire rim from cleansing supplies that may damage the tire rim. The figures are intended for representative purposes only and should not be considered to be limiting in any respect.

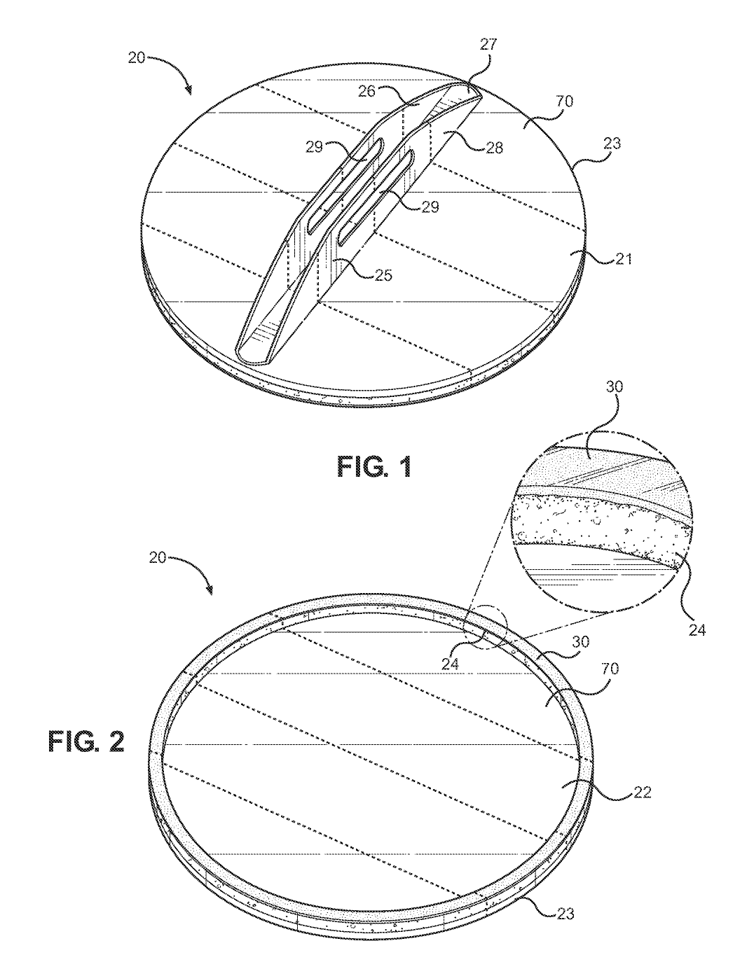

Referring now to FIGS. 1 and 2, there are shown a front perspective and a rear perspective of the tire rim detailing tool 20. The tire rim detailing tool 20 is a protective shield for the tire rim of a wheel, specifically configured to protect valuable tire rims from a variety of chemicals typically used when detailing tires. The tire rim detailing tool 20 includes a body portion 70, preferably circular in shape, however other shapes are likewise contemplated. In addition, the tire rim detailing tool 20 is produced in a variety of sizes appropriate for use with variously sized rims available on the market.

The body portion 70 includes a front side 21 and a rear side 22, wherein the rear side 22 is configured to be placed directly over a tire rim and an outer edge 23 of the body portion 70 is placed in contact against the tire. In this way, the tire cover 20 encloses the tire rim. The rear side 22 includes an absorbent pad 24 around the outer edge 23 of the body portion 70. In this way, the harsh chemicals and dressings used to enhance the appearance of tires will not drip onto the tire rim, which may leave undesirable and unattractive streaks, stains and marks that are associated with the use of the harsh chemicals and dressings. Possibly, the life of the tire rim can be extended. Preferably, the absorbent pad 24 is composed of foam rubber or sponge rubber, however, other suitable material that serve as a barrier to prevent these aforementioned cleaning supplies from contacting the tire rim are likewise contemplated.

The absorbent pad 24 further includes an adhesive 30, preferably a pressure sensitive adhesive, on an outside surface of the absorbent pad 24 that allows for the absorbent pad 24 to removably adhere to an inner edge of the tire. In this way, the cleaning supplies used to enhance the appearance of the tires will not be in contact with the tire rim to possibly damage the same. Preferably, the adhesive 30 is removably attached to the inner edge of the tire via a glue, however, other suitable means of adhesives are alternatively used in other embodiments, and likewise contemplated. When not in use, a liner can be placed over the adhesive 30 to prevent the adhesive 30 from sticking on itself or other areas.

The front side 21 includes a handle 25 that extends along a diameter of the body portion 70. The handle 25 is preferably U-shaped, wherein the handle 25 includes a first end 26, a middle portion 27, and a second end 28. The middle portion 27 is affixed to the front side 21 along the diameter of the body portion 70. The first end 26 and the second end 28 each include an aperture 29 that is configured to receive a user's hand therein. In this way, the handle 25 allows a user to hand grip the tire rim detailing tool 20 to removably adhere the tire rim detailing tool 20 to a tire.

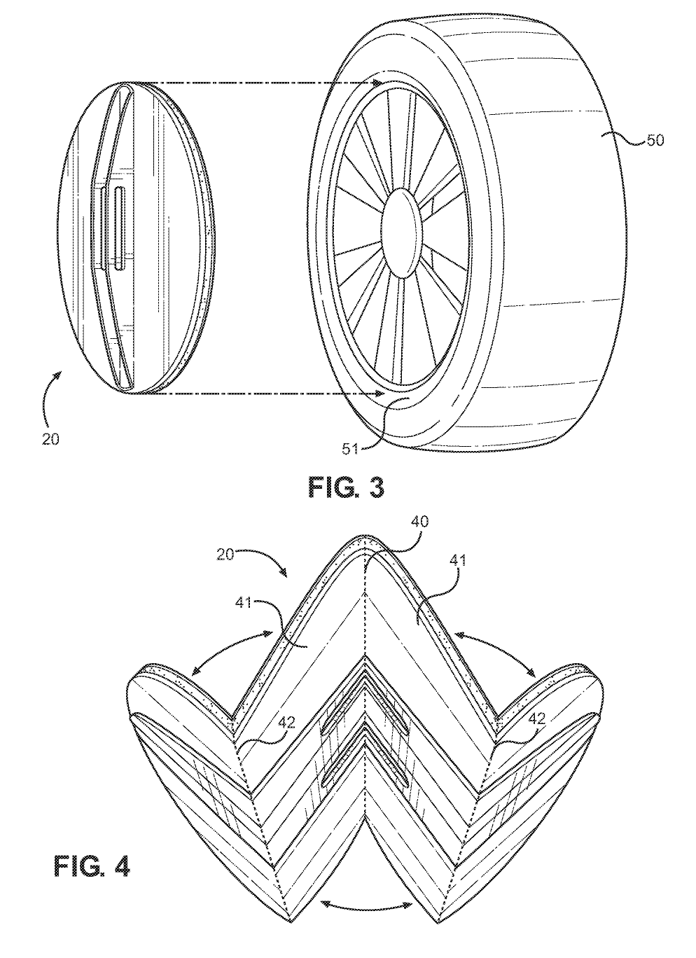

Referring now to FIG. 3, there is shown a side perspective of the tire rim detailing tool 20 as removably attached to a tire 50. The tire rim detailing tool 20 is configured to be removably adhered to an inner edge 51 of the tire 50 by an adhesive on the absorbent pad on the outer edge of the rear side. In this way, the tire rim detailing tool 20 blocks any cleaning supplies used to enhance the appearance of the tire 50 from being in contact with the tire rim, thereby preventing the cleaning supplies from damaging the tire rim. The front side of the tire rim detailing tool 20 includes a handle along a diameter of the tire rim detailing tool 20, which allows a user to removably fasten the tire rim detailing tool 20 to the inner edge 51 of the tire 50.

Referring now to FIG. 4, there is shown an overhead perspective of the tire rim detailing tool 20 folded for easy transport. Preferably, the tire rim detailing tool 20 is composed from a coated paperboard material, however, other materials such as a thermoset or thermoplastic material are alternatively used in other embodiments, and likewise contemplated. The tire rim detailing tool 20 is foldable along the diameter 40, which allows the tire rim detailing tool 20 to be folded into two halves 41. The tire rim detailing tool 20 is additionally foldable along a pair of chords 42 that are equidistant from the diameter 40 and that are parallel thereto, thereby each halve 41 is configured to fold onto itself along the chord 42. In this way, the tire rim detailing tool 20 can be folded into quarters for easy transport and storage. Each end of the handle 25 is configured to be collapsed and folded flat against the front side of the tire rim detailing tool. Furthermore, the handle 25 is also configured to be foldable along the diameter 40 and pair of chords 42, which also the handle 25 to be folded into quarters as well.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tire rim detailing tool, comprising:
a body portion having a front side and a rear side adapted to be removably secured to a surface of a tire rim;
said front side includes a handle;
said rear side includes an absorbent pad along an outer edge of said body portion;
wherein said absorbent pad is configured to be placed in contact with an inner edge of a tire.

2) The tire rim detailing tool of claim 1, wherein said absorbent pad comprises an adhesive that is configured to removably attach said absorbent pad to said inner edge of said tire.

3) The tire rim detailing tool of claim 1, wherein said body portion is circular in shape and sized appropriately to enclose said tire rim.

4) The tire rim detailing tool of claim 1, wherein:
said handle is substantially U-shaped and includes a first end, a middle portion, and a second end;
wherein said middle portion is affixed along a diameter of said body portion.

5) The tire rim detailing tool of claim 4, wherein said first end and said second end each include an aperture configured to allow said user to hand grip said handle.

6) The tire rim detailing tool claim 1, wherein said handle extends along said diameter of said body portion.

7) The tire rim detailing tool of claim 1, wherein said body portion is foldable into two halves along said diameter thereof.

8) The tire rim detailing tool of claim 7, wherein said body portion is additionally foldable along a pair of chords that are equidistant from said diameter to allow for easy storage and transport.

9) The tire rim detailing tool of claim 1, wherein said absorbent pad includes foam rubber.

10) The tire rim detailing tool of claim 1, wherein said absorbent pad includes sponge rubber.
